(19) United States
(12) Patent Application Publication
(10) Pub. No.: US 2008/0081565 A1
(43) Pub. Date: Apr. 3, 2008

(54) METHOD AND APPARATUS FOR PROVIDING ESTIMATION OF COMMUNICATION PARAMETERS

(76) Inventor: Kyeong Jin KIM, Irving, TX (US)

Correspondence Address: DITTHAVONG MORI & STEINER, P.C., 918 Prince St., Alexandria, VA, 22314, US

(21) Appl. No.: 11/864,027

(22) Filed: Sep. 28, 2007

Related U.S. Application Data
(60) Provisional application No. 60/827,491, filed on Sep. 29, 2006.

(51) Int. Cl. H04B 15/00

(52) U.S. Cl. 455/63.1

(57) ABSTRACT

An approach is provided for jointly determining a frequency offset estimate and a channel estimate using a parallel Schmidt-Kalman filter. A signal from a mobile terminal is received. A joint determination is made of a frequency offset estimate and a channel estimate of the received signal using a parallel Schmidt-Kalman filter. The frequency offset estimate and the channel estimate is used to remove interference from the received signal.

### RELATED APPLICATIONS

This application claims the benefit of the earlier filing date under 35 U.S.C. §119(e) of U.S. Provisional Application Ser. No. 60/827,491 filed Sep. 29, 2006, entitled “Method and Apparatus For Providing Frequency Offset and Channel Estimation,” the entirety of which is incorporated herein by reference.

### BACKGROUND

Radio communication systems provide users with the convenience of mobility along with a rich set of services and features. This convenience has spawned significant adoption by an ever growing number of consumers as an accepted mode of communication for business and personal uses in terms of communicating voice and data (including textual and graphical information). A continual challenge in such communication systems is that of combating signal interference, which becomes more problematic as the number of users in the system increase. To effectively minimize interference, reliable channel and frequency offset estimates are needed. Traditionally, such estimations are very difficult, particularly when the signals are transmitted over time-varying channels. These channel characteristics are reflective of a scenario involving mobile terminals.

### SOME EXEMPLARY EMBODIMENTS

Therefore, there is a need for an approach to provide channel and frequency offset estimation. According to one embodiment, joint frequency offset and channel estimates are determined for a MIMO (Multiple Input Multiple Output) OFDMA (Orthogonal Frequency Division Multiple Access) system over time-varying channels due to mobility.

According to one embodiment of the invention, a method comprises receiving a signal from a mobile terminal. The method also comprises jointly determining a frequency offset estimate and a channel estimate of the received signal using a parallel Schmidt-Kalman filter. The frequency offset estimate and the channel estimate is used to remove interference from the received signal.

According to another embodiment of the invention, an apparatus comprises a processor configured to receive a signal from a mobile terminal and to jointly determine a frequency offset estimate and a channel estimate of the received signal using a parallel Schmidt-Kalman filter. The frequency offset estimate and the channel estimate is used to remove interference from the received signal.

According to yet another embodiment of the invention, a system comprises a base station configured to receive a signal from a mobile terminal and to jointly determine a frequency offset estimate and a channel estimate of the received signal using a parallel Schmidt-Kalman filter. The frequency offset estimate and the channel estimate is used to remove interference from the received signal.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system utilizing a base station configured to provide frequency offset, channel and propagation estimates using Schmidt-Kalman filters, in accordance with an embodiment of the invention;

FIG. 2 is a diagram of a base station providing multiple processing blocks capable of processing frequency offset estimation and channel estimation using parallel Schmidt-Kalman filters, in accordance with an embodiment of the invention;

FIGS. 3A and 3B are flowcharts of processes for providing frequency offset estimation and channel estimation, in accordance with various embodiments of the invention;

FIG. 4 is a diagram of hardware that can be used to implement an embodiment of the invention;

FIGS. 5A and 5B are diagrams of different cellular mobile phone systems capable of supporting various embodiments of the invention;

FIG. 6 is a diagram of exemplary components of a mobile station capable of operating in the systems of FIGS. 5A and 5B, according to an embodiment of the invention; and

FIG. 7 is a diagram of an enterprise network capable of supporting the processes described herein, according to an embodiment of the invention.

### DESCRIPTION OF PREFERRED EMBODIMENTS

An apparatus, method, and software for providing estimation of communication parameters using Schmidt-Kalman filters are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a multi-input multi-output (MIMO) OFDMA (Orthogonal Frequency Division Multiple Access) system and Schmidt-Kalman filters, it is recognized by one of ordinary skill in the art that the embodiments of the inventions have applicability to any type of communication system and equivalent filtering techniques.

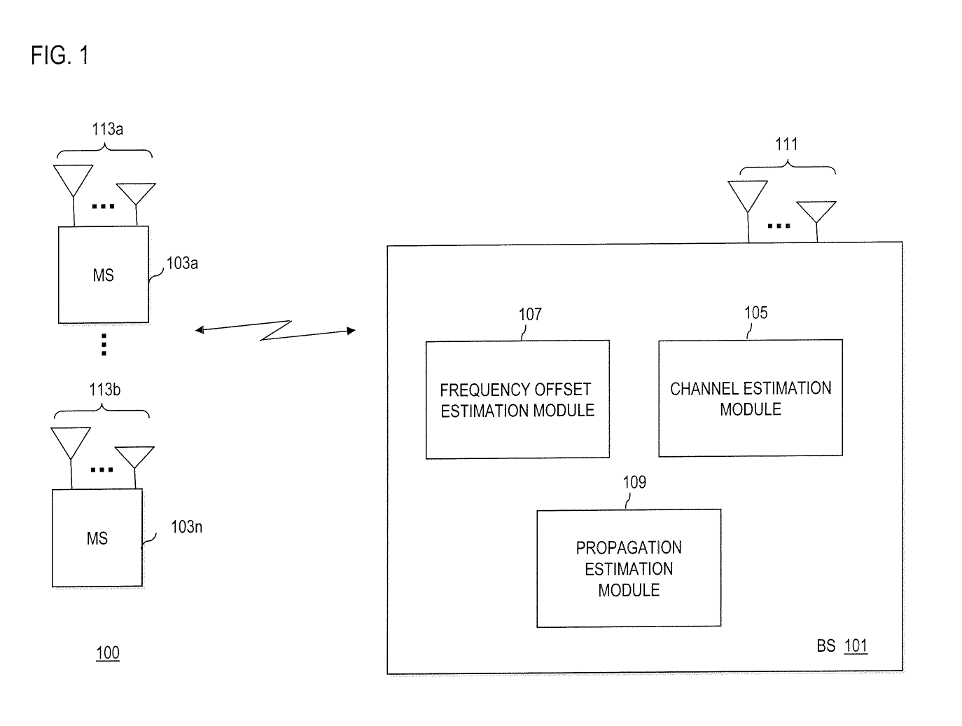

FIG. 1 is a diagram of a communication system utilizing a base station configured to provide frequency offset, channel and propagation estimates using Schmidt-Kalman filters, in accordance with an embodiment of the invention. For the purposes of illustration, a communication system 100 has a base station 101 in communication with one or more mobile stations (MS) 103a-103n. The terms “mobile station (MS),” “user equipment (UE),” “user terminal,” and “mobile node (MN),” are used interchangeably depending on the context to denote any type of client device or terminal. As shown, the base station 101 includes a channel estimation module 105 for generating channel estimates, and a frequency offset estimate module 107 to provide frequency offset estimates. In addition, a propagation estimation module 109 outputs estimates of the propagation delays. These estimates involve employing Schmidt-Kalman filtering, as later described.

According to certain embodiments, the system 100 is a MIMO (Multiple Input Multiple Output) OFDMA (Orthogonal Frequency Division Multiple Access) system. OFDMA, also referred to as Multi-User-OFDM, is being considered as a modulation and multiple access method for 4^{th} generation wireless networks. OFDMA is an extension of Orthogonal Frequency Division Multiplexing (OFDM), which is currently the modulation of choice for high speed data access systems such as IEEE 802.11a/g/n wireless LAN (WiFi) (Wireless Fidelity) and IEEE 802.16a/d/e wireless broadband access systems (WiMAX) (Worldwide Interoperability for Microwave Access). OFDMA allows multiple users to transmit simultaneously on the different subcarriers.

In the MIMO system 100, a transmitter (which can be the mobile station 103 or the base station 101) can simultaneously transmit multiple data streams from multiple antennas. The receiver (e.g., mobile station 103 or base station 101) can receive the transmitted streams via multiple antennas, where the receiver can derive channel response matrix based on received pilot symbols, and perform receiver spatial processing. The receiver can combine the signals to obtain an enhanced channel response signal.

The OFDM system 100 (with a frequency domain equalization method) can support high speed data while maintaining high signal quality even under severe multi-path fading environments. To realize the potential performances of OFDM technique, a highly accurate channel estimator is needed. Specifically, to eliminate interfering signals from a received vector signal for a desired user, reliable channel and frequency offset estimates are determined. By way of example, in an uplink-MIMO-OFDMA (UL-MIMO-OFDMA) system, it is difficult, using traditional approaches, to estimate and track the offset and channel parameters largely because of the mobility of the devices. It is contemplated that this approach can be implemented in other applications using the OFDM waveform.

Several approaches have been proposed for addressing frequency offset and channel estimation. For example, a maximum likelihood (ML) approach is used for a joint estimation, in which the alternating-projection is employed for the frequency offset estimation. Also, a subspace based frequency offset estimate is proposed. However, since high Doppler shift will be experienced in the outdoor due to high mobility, these approaches may not be suitable in a practical time-varying environment. Also, the conventional approaches are not reliable to estimate frequency offset in time-varying environment. For a joint estimation, a nonlinear filtering technique is used in the MIMO-OFDM system. However, this approach is based on the nonlinear filtering approach based on the Kalman filter, and thus, may not be suitable for a parallel processing.

By contrast, the base station 101, according with some embodiments, provide joint frequency offset and channel estimation for the MIMO-OFDMA system 100 over time varying channels by employing Schmidt-Kalman Filters in parallel. In an OFDM system, frequency offset estimation is an important part to maintain the carrier orthogonality. In the MIMO-OFDMA system 100, the transmitter (e.g., MS 103 or BS 101) can simultaneously transmit multiple data streams on multiple subbands using multiple antennas—e.g., antennas 111 of the base station 101, or antennas 113a-113n of the mobile stations 103a-103n.

In an alternative embodiment, for the estimation process can be implemented in a single-carrier system without OFDM. In such a case, the channel estimation is performed for one subband. For a wideband single-carrier system, various techniques may be used to account for frequency selectivity in the wideband channel.

It is noted that the channel estimation and frequency offset estimation associated with data processing techniques described herein can be used for the downlink as well as the uplink in the wireless communication system 100. The downlink refers to the communication link from the base station 101 to the user terminal 103, and the uplink refers to the communication link from the user terminal 103 to the base station 101.

Furthermore, the base station 101 can operate in a MIMO-CDMA (Code Division Multiple Access) system to provide joint channel and propagation delay estimations, per channel estimation module 105 and propagation estimation module 109.

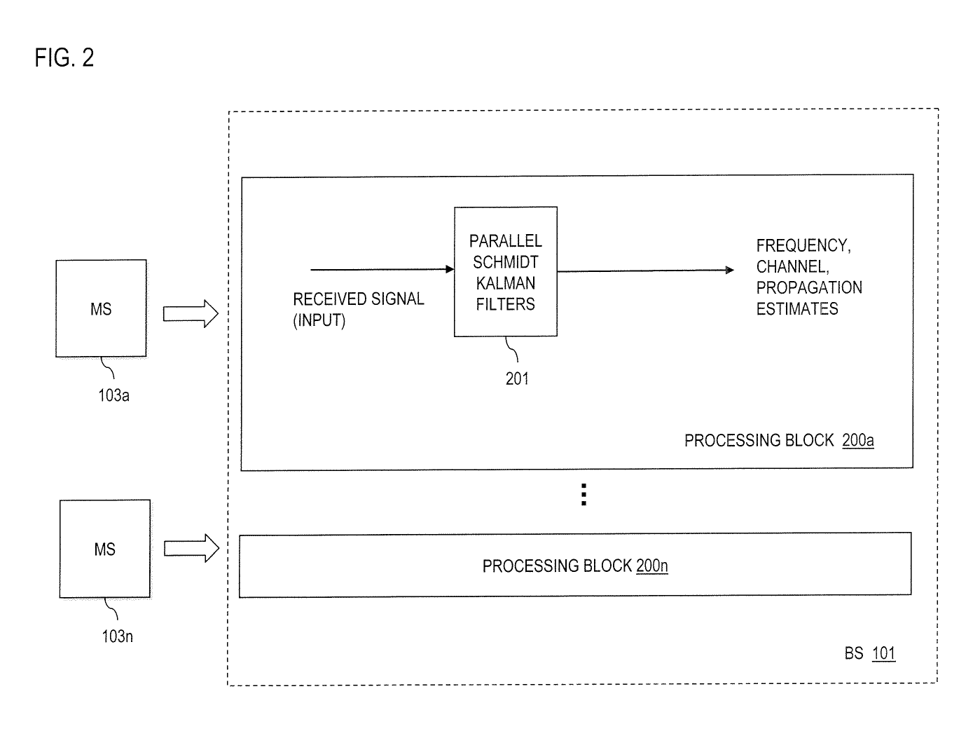

FIG. 2 is a diagram of a base station providing multiple processing blocks capable of processing frequency offset estimation and channel estimation using parallel Schmidt-Kalman filters, in accordance with an embodiment of the invention. In an exemplary architecture, the base station 101 of FIG. 1 utilizes multiple processing blocks 200a-200n to perform the joint estimation processes. The number of processing blocks 200a-200n corresponding to the number of mobile stations 113a-113n that are involved in the communication.

Each processing block 200a includes parallel Schmidt-Kalman filters 201 that output, for instance, frequency offset estimates and a channel estimates based on received signals over a time varying channel. The processing blocks 200a-200n provide a parallel processing scheme that can operate to estimate phase noise as well as track channel offset and channel estimation.

The Schmidt-Kalman filters 201 minimize the computational load on the processor, by elimination of states of no interest. The elimination can be accomplished by partitioning the measurement and propagation equations:

$${[ \begin{matrix}x \\ y\end{matrix} ]}_{k + 1} = {[ \begin{matrix}{φ}_{x} & 0 \\ 0 & {φ}_{y}\end{matrix} ] [ \begin{matrix}x \\ y\end{matrix} ]}_{k} + {[ \begin{matrix}{w}_{x} \\ {w}_{y}\end{matrix} ]}_{k}$$

$${z}_{k} = {{[ H J ]}_{k} [ \begin{matrix}x \\ y\end{matrix} ]}_{k} + {v}_{k}$$

$${P}_{k} = {[ \begin{matrix}{P}_{xx} & {P}_{yx} \\ {P}_{xy} & {P}_{yy}\end{matrix} ]}_{k}$$

where x represents the vector containing the states of interest (e.g., channel state).

After filtering the received signals, the filtered signals (parallel filtered outputs) can be encoded and interleaved at an encoder (not shown), then modulated at a modulator (not shown) that may be fixed or adaptive. Any noise in the filtered data can be cancelled through a noise cancellation process and fed into the antennas for transmission of the filtered signals to a targeted terminal 103. Upon receiving the filtered data, a local oscillator (not shown) of terminal 103 can be adjusted according to the frequency offset estimates.

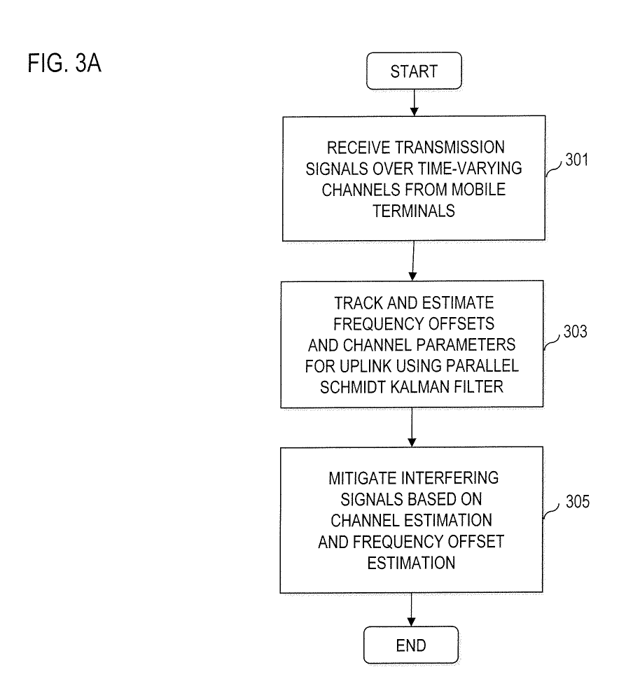

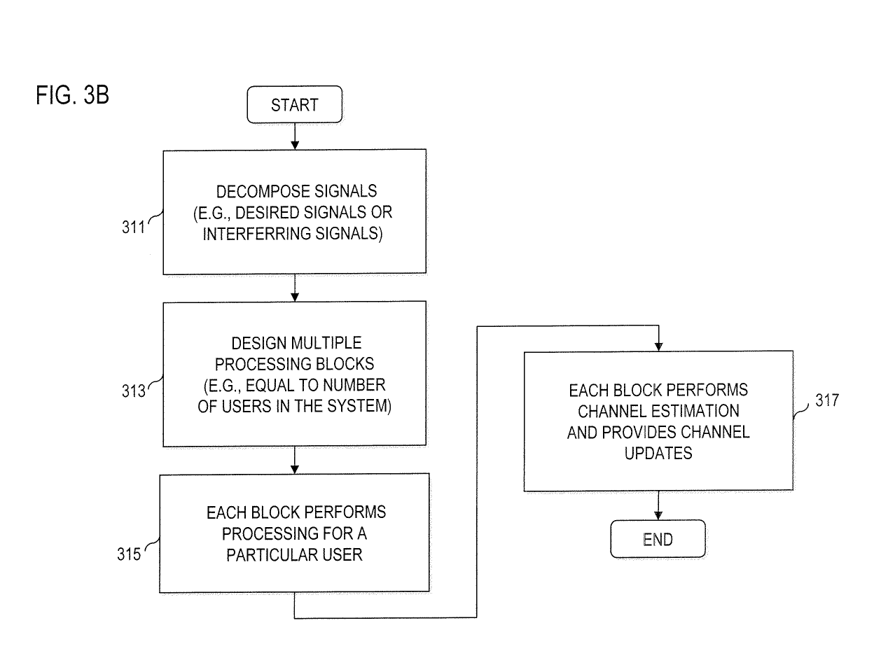

FIGs. 3A and 3B are flowcharts of processes for providing frequency offset estimation and channel estimation, in accordance with various embodiments of the invention. As seen in FIG. 3A, in step 301, transmission signals are received over time-varying channels from a mobile terminal 103a. In step 303, the process then tracks and estimates the frequency offsets and channel parameters for the transmission link (e.g., uplink) using parallel Schmidt-Kalman filters (e.g., filters 201). Using the channel and frequency offset estimates, the process can mitigate interfering signals (step 305).

To compute the Kalman gain, O(N³) multiplications and additions for A⁻¹, K×O(N(K−1)(Nₜ(N_{f}+1))²N) multiplications and additions for all Kₖ^{q}(n), an original Kalman gain, and K×O(N(K−1)²(Nₜ(N_{f}+1))²N) multiplications and additions for all K_{q/k}(n), a Schmidt-Kalman gain, are needed. From these facts, as the number of mobile stations 103a-103n increases, the parallel Schmidt-Kalman filtering approach is more desirable. It is observed that there is no need to model the interference as a simple AWGN (Additive White Gaussian Noise) in practical MIMO-OFDMA systems.

With respect to FIG. 3B, in step 311, the process decomposes the signal into a desired signal and interfering signal. Next, multiple processing blocks 200a-200n are created. By way of example, the number of processing blocks is equal to the total number of mobile stations 103a-103n (or users) in the system (step 313). Each block 200a performs processing for only a desired user, as in step 315. In an exemplary embodiment, per step 317, each block 200a-200n performs channel estimation and channel update.

The processes of FIGS. 3A and 3B, in an exemplary embodiment, provide a lower complexity channel estimation/frequency offset algorithm for multi-user uplink MIMO relative to the optimal Kalman filter, which estimates jointly all user channel estimates. This approach is a better approach than treating all other users as AWGN. It is also more superior to using a probabilistic data association filter (PDAF), which models other users with some probability distribution function (PDF) that reflects asynchronism of data streams. The estimation process, in one embodiment, exploits the second order statistics of the interfering users in an optimal way by not estimating the interferers.

Further, the processes scale well with the number of antennas, size of FFT (Fast Fourier Transform), and number of users for each receive antenna. The processing is of vector-matrix multiplications and addition and can be easily implemented in typical DSPs (Digital Signal Processors) with vector-matrix packages.

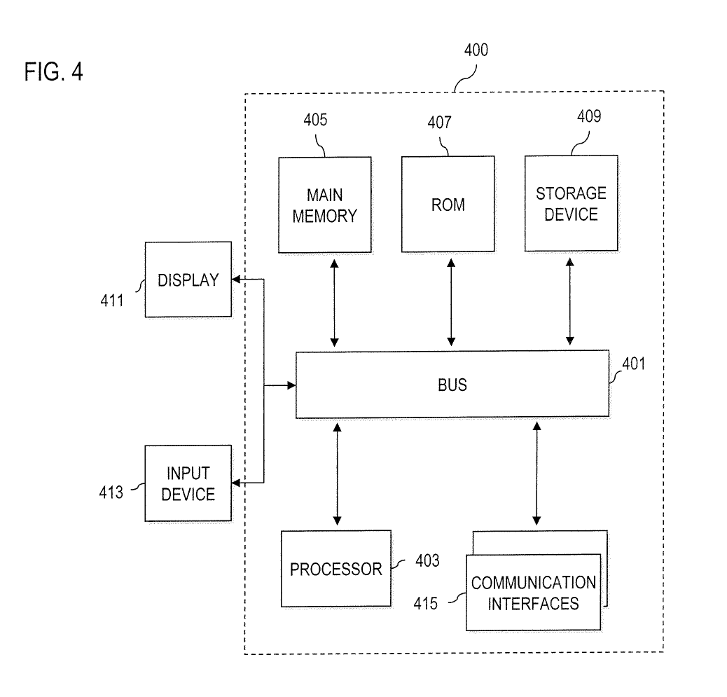

One of ordinary skill in the art would recognize that the described estimation processes may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 4.

FIG. 4 illustrates exemplary hardware upon which various embodiments of the invention can be implemented. A computing system 400 includes a bus 401 or other communication mechanism for communicating information and a processor 403 coupled to the bus 401 for processing information. The computing system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computing system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computing system 400 may be coupled via the bus 401 to a display 411, such as a liquid crystal display, or active matrix display, for displaying information to a user. An input device 413, such as a keyboard including alphanumeric and other keys, may be coupled to the bus 401 for communicating information and command selections to the processor 403. The input device 413 can include a cursor control, such as a mouse, a trackball, or cursor direction keys, for communicating direction information and command selections to the processor 403 and for controlling cursor movement on the display 411.

According to various embodiments of the invention, the processes described herein can be provided by the computing system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 400 also includes at least one communication interface 415 coupled to bus 401. The communication interface 415 provides a two-way data communication coupling to a network link (not shown). The communication interface 415 sends and receives electrical, electromagnetic, or optical signals that carry digital data streams representing various types of information. Further, the communication interface 415 can include peripheral interface devices, such as a Universal Serial Bus (USB) interface, a PCMCIA (Personal Computer Memory Card International Association) interface, etc.

The processor 403 may execute the transmitted code while being received and/or store the code in the storage device 409, or other non-volatile storage for later execution. In this manner, the computing system 400 may obtain application code in the form of a carrier wave.

The term “computer-readable medium” as used herein refers to any medium that participates in providing instructions to the processor 403 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

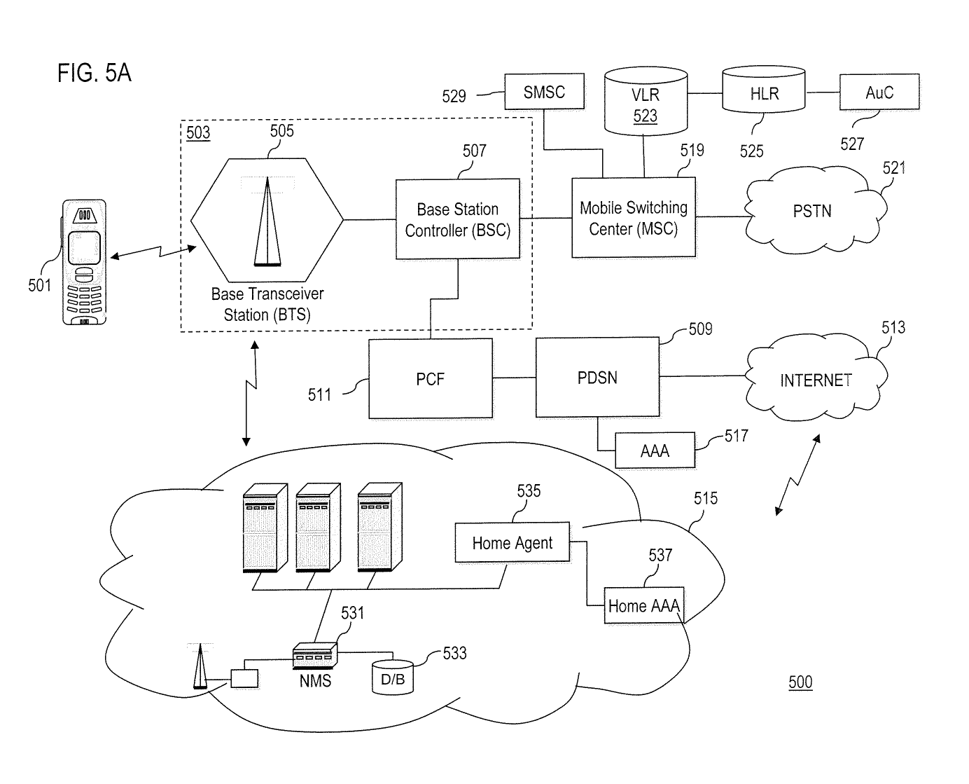

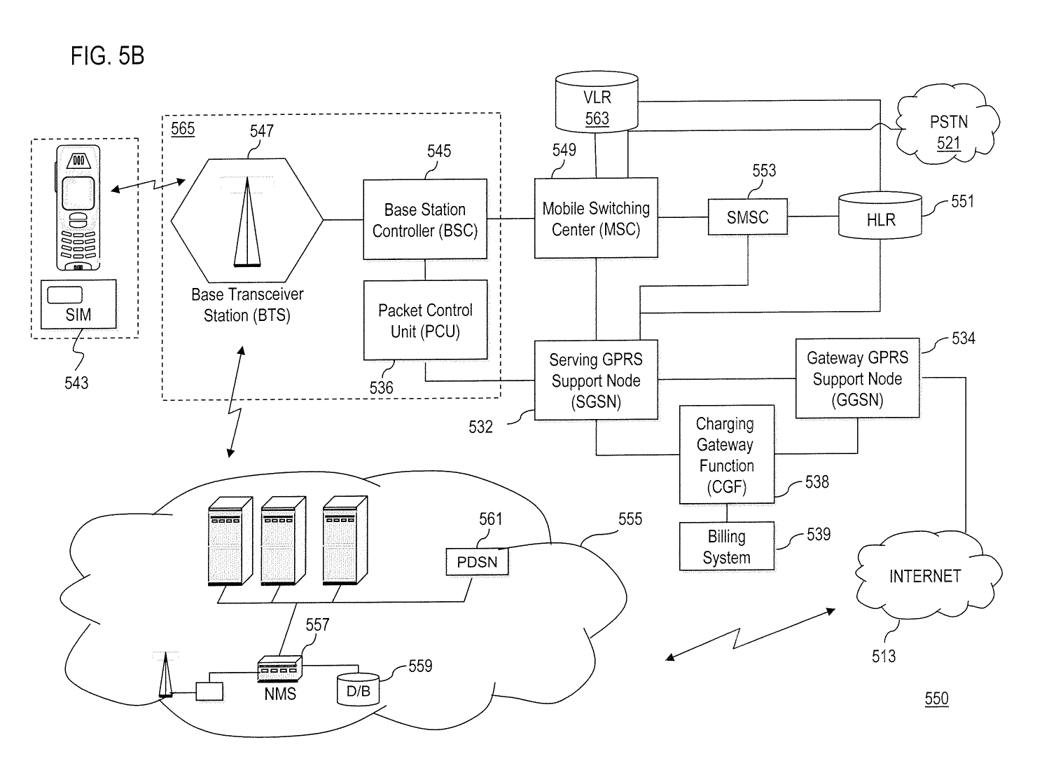

FIGS. 5A and 5B are diagrams of different cellular mobile phone systems capable of supporting various embodiments of the invention. FIGS. 5A and 5B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 500 includes mobile stations 501 (e.g., handsets, terminals, stations, units, devices, or any type of interface to the user (such as “wearable” circuitry, etc.)) in communication with a Base Station Subsystem (BSS) 503. According to one embodiment of the invention, the radio network supports Third Generation (3G) services as defined by the International Telecommunications Union (ITU) for International Mobile Telecommunications 2000 (IMT-2000).

In this example, the BSS 503 includes a Base Transceiver Station (BTS) 505 and Base Station Controller (BSC) 507. Although a single BTS is shown, it is recognized that multiple BTSs are typically connected to the BSC through, for example, point-to-point links. Each BSS 503 is linked to a Packet Data Serving Node (PDSN) 509 through a transmission control entity, or a Packet Control Function (PCF) 511. Since the PDSN 509 serves as a gateway to external networks, e.g., the Internet 513 or other private consumer networks 515, the PDSN 509 can include an Access, Authorization and Accounting system (AAA) 517 to securely determine the identity and privileges of a user and to track each user's activities. The network 515 comprises a Network Management System (NMS) 531 linked to one or more databases 533 that are accessed through a Home Agent (HA) 535 secured by a Home AAA 537.

Although a single BSS 503 is shown, it is recognized that multiple BSSs 503 are typically connected to a Mobile Switching Center (MSC) 519. The MSC 519 provides connectivity to a circuit-switched telephone network, such as the Public Switched Telephone Network (PSTN) 521. Similarly, it is also recognized that the MSC 519 may be connected to other MSCs 519 on the same network 500 and/or to other radio networks. The MSC 519 is generally collocated with a Visitor Location Register (VLR) 523 database that holds temporary information about active subscribers to that MSC 519. The data within the VLR 523 database is to a large extent a copy of the Home Location Register (HLR) 525 database, which stores detailed subscriber service subscription information. In some implementations, the HLR 525 and VLR 523 are the same physical database; however, the HLR 525 can be located at a remote location accessed through, for example, a Signaling System Number 7 (SS7) network. An Authentication Center (AuC) 527 containing subscriber-specific authentication data, such as a secret authentication key, is associated with the HLR 525 for authenticating users. Furthermore, the MSC 519 is connected to a Short Message Service Center (SMSC) 529 that stores and forwards short messages to and from the radio network 500.

During typical operation of the cellular telephone system, BTSs 505 receive and demodulate sets of reverse-link signals from sets of mobile units 501 conducting telephone calls or other communications. Each reverse-link signal received by a given BTS 505 is processed within that station. The resulting data is forwarded to the BSC 507. The BSC 507 provides call resource allocation and mobility management functionality including the orchestration of soft handoffs between BTSs 505. The BSC 507 also routes the received data to the MSC 519, which in turn provides additional routing and/or switching for interface with the PSTN 521. The MSC 519 is also responsible for call setup, call termination, management of inter-MSC handover and supplementary services, and collecting, charging and accounting information. Similarly, the radio network 500 sends forward-link messages. The PSTN 521 interfaces with the MSC 519. The MSC 519 additionally interfaces with the BSC 507, which in turn communicates with the BTSs 505, which modulate and transmit sets of forward-link signals to the sets of mobile units 501.

As shown in FIG. 5B, the two key elements of the General Packet Radio Service (GPRS) infrastructure 550 are the Serving GPRS Supporting Node (SGSN) 532 and the Gateway GPRS Support Node (GGSN) 534. In addition, the GPRS infrastructure includes a Packet Control Unit PCU (536) and a Charging Gateway Function (CGF) 538 linked to a Billing System 539. A GPRS the Mobile Station (MS) 541 employs a Subscriber Identity Module (SIM) 543.

The PCU 536 is a logical network element responsible for GPRS-related functions such as air interface access control, packet scheduling on the air interface, and packet assembly and re-assembly. Generally the PCU 536 is physically integrated with the BSC 545; however, it can be collocated with a BTS 547 or a SGSN 532. The SGSN 532 provides equivalent functions as the MSC 549 including mobility management, security, and access control functions but in the packet-switched domain. Furthermore, the SGSN 532 has connectivity with the PCU 536 through, for example, a Fame Relay-based interface using the BSS GPRS protocol (BSSGP). Although only one SGSN is shown, it is recognized that that multiple SGSNs 531 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 545, any given BSC 545 generally interfaces with one SGSN 532. Also, the SGSN 532 is optionally connected with the HLR 551 through an SS7-based interface using GPRS enhanced Mobile Application Part (MAP) or with the MSC 549 through an SS7-based interface using Signaling Connection Control Part (SCCP). The SGSN/HLR interface allows the SGSN 532 to provide location updates to the HLR 551 and to retrieve GPRS-related subscription information within the SGSN service area. The SGSN/MSC interface enables coordination between circuit-switched services and packet data services such as paging a subscriber for a voice call. Finally, the SGSN 532 interfaces with a SMSC 553 to enable short messaging functionality over the network 550.

The GGSN 534 is the gateway to external packet data networks, such as the Internet 513 or other private customer networks 555. The network 555 comprises a Network Management System (NMS) 557 linked to one or more databases 559 accessed through a PDSN 561. The GGSN 534 assigns Internet Protocol (IP) addresses and can also authenticate users acting as a Remote Authentication Dial-In User Service host. Firewalls located at the GGSN 534 also perform a firewall function to restrict unauthorized traffic. Although only one GGSN 534 is shown, it is recognized that a given SGSN 532 may interface with one or more GGSNs 533 to allow user datato be tunneled between the two entities as well as to and from the network 550. When external data networks initialize sessions over the GPRS network 550, the GGSN 534 queries the HLR 551 for the SGSN 532 currently serving a MS 541.

The BTS 547 and BSC 545 manage the radio interface, including controlling which Mobile Station (MS) 541 has access to the radio channel at what time. These elements essentially relay messages between the MS 541 and SGSN 532. The SGSN 532 manages communications with an MS 541, sending and receiving data and keeping track of its location. The SGSN 532 also registers the MS 541, authenticates the MS 541, and encrypts data sent to the MS 541.

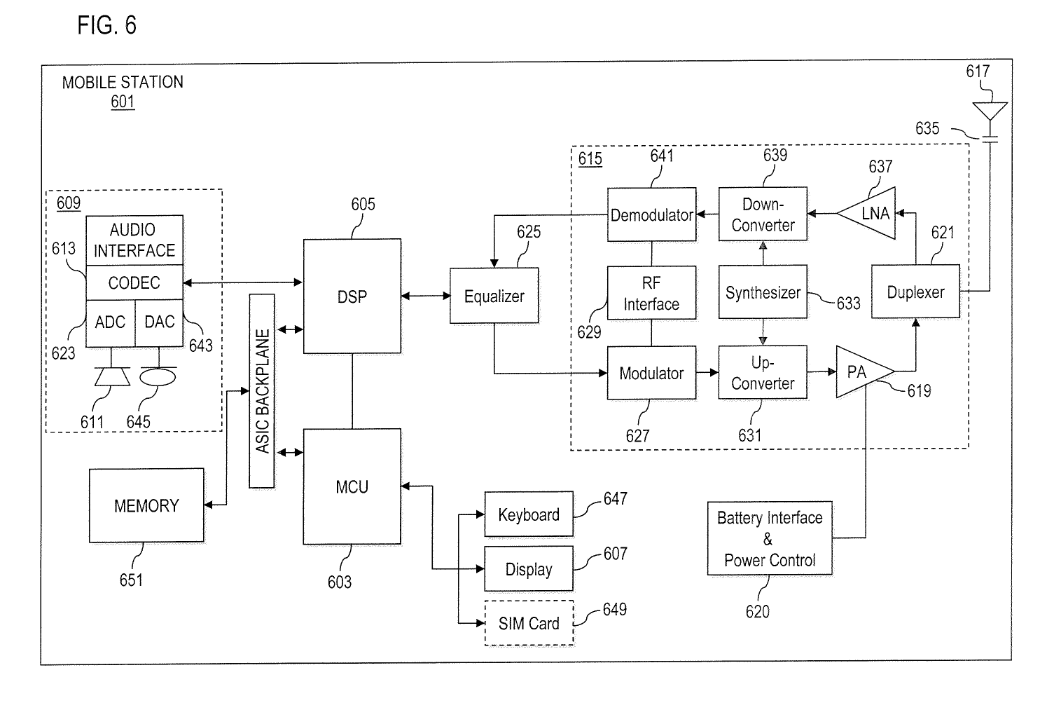

FIG. 6 is a diagram of exemplary components of a mobile station (e.g., handset) capable of operating in the systems of FIGS. 5A and 5B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 603, a Digital Signal Processor (DSP) 605, and a receiver/transmitter unit including a microphone gain control unit and a speaker gain control unit. A main display unit 607 provides a display to the user in support of various applications and mobile station functions. An audio function circuitry 609 includes a microphone 611 and microphone amplifier that amplifies the speech signal output from the microphone 611. The amplified speech signal output from the microphone 611 is fed to a coder/decoder (CODEC) 613.

A radio section 615 amplifies power and converts frequency in order to communicate with a base station, which is included in a mobile communication system (e.g., systems of FIG. 5A or 5B), via antenna 617. The power amplifier (PA) 619 and the transmitter/modulation circuitry are operationally responsive to the MCU 603, with an output from the PA 619 coupled to the duplexer 621 or circulator or antenna switch, as known in the art. The PA 619 also couples to a battery interface and power control unit 620.

In use, a user of mobile station 601 speaks into the microphone 611 and his or her voice along with any detected background noise is converted into an analog voltage. The analog voltage is then converted into a digital signal through the Analog to Digital Converter (ADC) 623. The control unit 603 routes the digital signal into the DSP 605 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 625 for compensation of any frequency-dependent impairments that occur during transmission though the air such as phase and amplitude distortion. After equalizing the bit stream, the modulator 627 combines the signal with a RF signal generated in the RF interface 629. The modulator 627 generates a sine wave by way of frequency or phase modulation. In order to prepare the signal for transmission, an up-converter 631 combines the sine wave output from the modulator 627 with another sine wave generated by a synthesizer 633 to achieve the desired frequency of transmission. The signal is then sent through a PA 619 to increase the signal to an appropriate power level. In practical systems, the PA 619 acts as a variable gain amplifier whose gain is controlled by the DSP 605 from information received from a network base station. The signal is then filtered within the duplexer 621 and optionally sent to an antenna coupler 635 to match impedances to provide maximum power transfer. Finally, the signal is transmitted via antenna 617 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 601 are received via antenna 617 and immediately amplified by a low noise amplifier (LNA) 637. A down-converter 639 lowers the carrier frequency while the demodulator 641 strips away the RF leaving only a digital bit stream. The signal then goes through the equalizer 625 and is processed by the DSP 605. A Digital to Analog Converter (DAC) 643 converts the signal and the resulting output is transmitted to the user through the speaker 645, all under control of a Main Control Unit (MCU) 603—which can be implemented as a Central Processing Unit (CPU) (not shown).

The MCU 603 receives various signals including input signals from the keyboard 647. The MCU 603 delivers a display command and a switch command to the display 607 and to the speech output switching controller, respectively. Further, the MCU 603 exchanges information with the DSP 605 and can access an optionally incorporated SIM card 649 and a memory 651. In addition, the MCU 603 executes various control functions required of the station. The DSP 605 may, depending upon the implementation, perform any of a variety of conventional digital processing functions on the voice signals. Additionally, DSP 605 determines the background noise level of the local environment from the signals detected by microphone 611 and sets the gain of microphone 611 to a level selected to compensate for the natural tendency of the user of the mobile station 601.

The CODEC 613 includes the ADC 623 and DAC 643. The memory 651 stores various data including call incoming tone data and is capable of storing other data including music data received via, e.g., the global Internet. The software module could reside in RAM memory, flash memory, registers, or any other form of writable storage medium known in the art. The memory device 651 may be, but not limited to, a single memory, CD, DVD, ROM, RAM, EEPROM, optical storage, or any other non-volatile storage medium capable of storing digital data.

An optionally incorporated SIM card 649 carries, for instance, important information, such as the cellular phone number, the carrier supplying service, subscription details, and security information. The SIM card 649 serves primarily to identify the mobile station 601 on a radio network. The card 649 also contains a memory for storing a personal telephone number registry, text messages, and user specific mobile station settings.

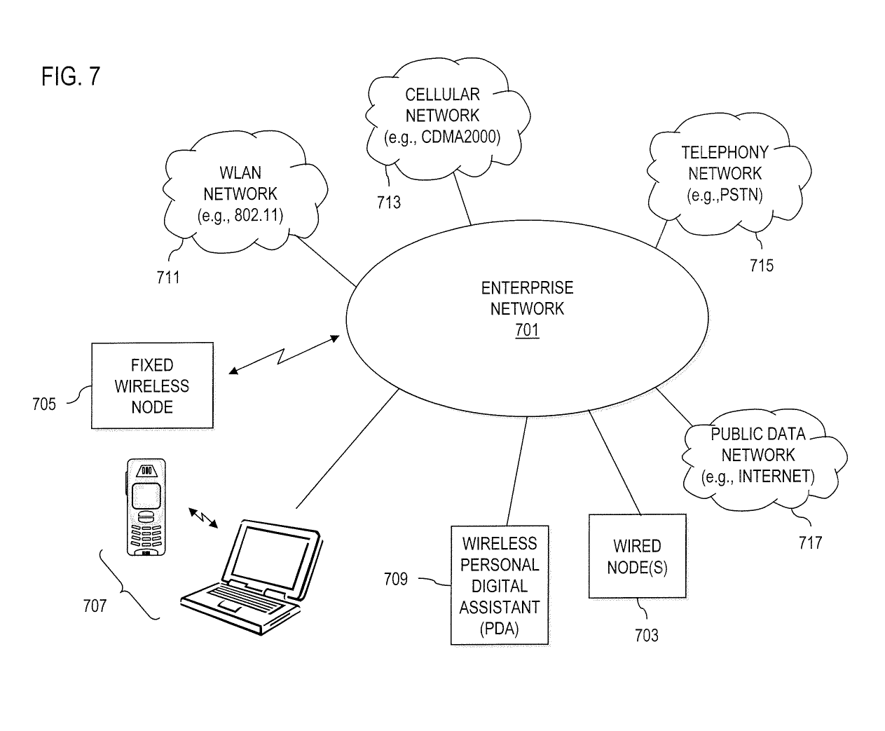

FIG. 7 shows an exemplary enterprise network, which can be any type of data communication network utilizing packet-based and/or cell-based technologies (e.g., Asynchronous Transfer Mode (ATM), Ethernet, IP-based, etc.). The enterprise network 701 provides connectivity for wired nodes 703 as well as wireless nodes 705-709 (fixed or mobile), which are each configured to perform the processes described above. The enterprise network 701 can communicate with a variety of other networks, such as a WLAN network 2311 (e.g., IEEE 802.11), a cdma2000 cellular network 713, a telephony network 716 (e.g., PSTN), or a public data network 717 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a signal from a mobile terminal; and
jointly determining a frequency offset estimate and a channel estimate of the received signal using a parallel Schmidt-Kalman filter,
wherein the frequency offset estimate and the channel estimate is used to remove interference from the received signal.

2. A method according to claim 1, wherein the signal is received over a multiple input multiple output (MIMO) channel.

3. A method according to claim 2, wherein the channel is compliant with an Orthogonal Frequency Division Multiple Access (OFDMA) scheme.

4. A method according to claim 2, wherein the channel is compliant with a Code Division Multiple Access (CDMA) scheme.

5. A method according to claim 4, wherein the parallel Schmidt-Kalman filter outputs a propagation delay estimate for the received signal.

6. A method according to claim 1, wherein the mobile terminal is among a plurality of mobile terminals, the method further comprising:
receiving a plurality of signals from the mobile terminals; and
concurrently determining a frequency offset estimate and a channel estimate for each of the mobile terminals.

7. An apparatus comprising:
a processor configured to receive a signal from a mobile terminal and to jointly determine a frequency offset estimate and a channel estimate of the received signal using a parallel Schmidt-Kalman filter,
wherein the frequency offset estimate and the channel estimate is used to remove interference from the received signal.

8. An apparatus according to claim 7, wherein the signal is received over a multiple input multiple output (MIMO) channel.

9. An apparatus according to claim 8, wherein the channel is compliant with an Orthogonal Frequency Division Multiple Access (OFDMA) scheme.

10. An apparatus according to claim 8, wherein the channel is compliant with a Code Division Multiple Access (CDMA) scheme.

11. An apparatus according to claim 10, wherein the parallel Schmidt-Kalman filter outputs a propagation delay estimate for the received signal.

12. An apparatus according to claim 7, further comprising:
another processor configured to receive another signal from another mobile terminal and to determine a frequency offset estimate and a channel estimate for the other mobile terminal, wherein the processors are configured to operate concurrently to generate the frequency offset estimates and the channel estimates.

13. A system comprising:
a base station configured to receive a signal from a mobile terminal and to jointly determine a frequency offset estimate and a channel estimate of the received signal using a parallel Schmidt-Kalman filter,
wherein the frequency offset estimate and the channel estimate is used to remove interference from the received signal.

14. A system according to claim 13, wherein the signal is received over a multiple input multiple output (MIMO) channel.

15. A system according to claim 14, wherein the channel is compliant with an Orthogonal Frequency Division Multiple Access (OFDMA) scheme.

16. A system according to claim 14, wherein the channel is compliant with a Code Division Multiple Access (CDMA) scheme.

17. A system according to claim 16, wherein the parallel Schmidt-Kalman filter outputs a propagation delay estimate for the received signal.

18. A system according to claim 13, wherein the base station is further configured to receive another signal from another mobile terminal and to determine a frequency offset estimate and a channel estimate for the other mobile terminal, wherein the processors are configured to operate concurrently to generate the frequency offset estimates and the channel estimates.
